(19) United States
(12) Patent Application Publication
(10) Pub. No.: US 2006/0241937 A1
(43) Pub. Date: Oct. 26, 2006

(54) Method and apparatus for automatically discriminating information bearing audio segments and background noise audio segments

(76) Inventor: Changxue C. Ma, Barrington, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/111,385

(22) Filed: Apr. 21, 2005

(51) Int. Cl. G10L 11/04

(52) U.S. Cl. 704/206

(57) ABSTRACT

A system (100) for automatically discriminating information bearing audio segments and mere background noise segments processes digitized audio to extract two discriminants between information bearing audio and mere background audio that have a relatively low correlation. One discriminant is based on the rate (relative to the sample rate) at which a specified Boolean test involving sample values is met. Another possible discriminant is based on the variance of time-frequency magnitudes in a number of time windows and frequency bands. The two discriminants are suitably used as the independent variables of probability density functions that model information bearing audio and background noise audio.

### FIELD OF THE INVENTION

The present invention relates in general to audio processing. More particularly, the present invention relates to discrimination between noise and information bearing audio.

### BACKGROUND

Progress in microelectronics has made possible ubiquitous use of ever more powerful and inexpensive microprocessors. The availability of low cost high performance microprocessors has facilitated widespread adaptation of technologies that rely on what was previously considered to be computationally intensive multimedia processing. Among these technologies are digital communications and technologies that use automatic speech recognition.

An important subcategory within digital communication is digital voice communication. At present most cellular communication networks use digital voice encoding. Digital voice encoding allows the spectrum available for wireless communications to be used much more efficiently. Moreover, public landline telephone networks are also being digitized so that telephone service can be more efficiently integrated with other data services.

Speech recognition technology is used in a variety of applications including software for automatically transcribing spoken language, foreign language training software, and software systems that accept spoken commands. Familiar examples in the latter category are systems that are accessed by telephone and allow users to navigate hierarchical menus of options by voice command in order to obtain information or perform billing transactions.

Spoken language includes pauses between words and between sentences. When the pauses occur, only background noise will be picked up by a microphone that is being used to input speech. When speech is being digitally encoded for digital voice communications it is useful to be able to recognize when a speaker has paused and stop encoding the audio picked up by the microphone. Ceasing the encoding avoids wasted use of network bandwidth to digitally encode background noise.

In the context of speech recognition applications it is to be noted that by recognizing the pauses between words one is recognizing the beginning and ends of words. If the temporal bounds of the words are known the accuracy of speech recognition process will be improved, and computational resources will be conserved because no attempt will be made to find a phoneme model that matches the background noise.

Thus, in both digital voice communication and speech recognition it is useful to be able to discriminate speech in input audio. Given, that digital voice technology has moved out of the laboratory into widespread real world use, it is often used in noisy background environments such as in cars or in crowded places where the cacophony of many people at various distances speaking at once creates background noise. Some background noise is stationary and other noise is transient. The variety of noise makes it more difficult to distinguish speech from background noise, and thus difficult to discriminate pauses in speech.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a functional block diagram of a system for automatically distinguishing information bearing audio segments from background noise segments according to an embodiment;

FIG. 2 is a more detailed block diagram of a decision block in the system shown in FIG. 1 according to the embodiment;

FIG. 3 is flowchart of a process for automatically distinguishing information bearing audio segments from pure background noise segments according to the embodiment;

FIG. 4 is a flowchart of a process of establishing a threshold used in the system shown in FIG. 1 and in the process shown in FIG. 3;

FIG. 5 is an audio waveform including an information bearing segment, between two background noise segments;

FIG. 6 is a graph including a time domain plot of a ‘Soft Zero Crossing’ based discriminant between information bearing audio segments and pure background noise segments for the audio waveform shown in FIG. 4;

FIG. 7 is a graph including a time domain plot of a Joint Time-Frequency Analysis derived discriminant that discriminates between information bearing audio segments and pure background noise segments plotted for the audio waveform shown in FIG. 4;

FIG. 8 is a graph including level plots for Gaussian mixture components of a model for background noise and a model for audio segments with speech that are based on the discriminant plotted in FIG. 6 and the discriminant plotted in FIG. 7;

FIG. 9 is graph including a time domain plot of a probability score yielded by the model for background noise shown in FIG. 8 and a time domain plot of a probability score yielded by the model for speech shown in FIG. 8 when evaluated with the audio waveform shown in FIG. 5; and

FIG. 10 is a hardware block diagram of the system shown in FIG. 1 according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to automatically discriminating information bearing audio segments and background noise audio segments. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for automatically discriminating information bearing audio segments and background noise audio segments described herein. The non-processor circuits may include, but are not limited to, a radio receiver, a radio transmitter, signal drivers, clock circuits, power source circuits, and user input devices. As such, these functions may be interpreted as steps of a method to perform automatic discrimination information bearing audio segments and background noise audio segments. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

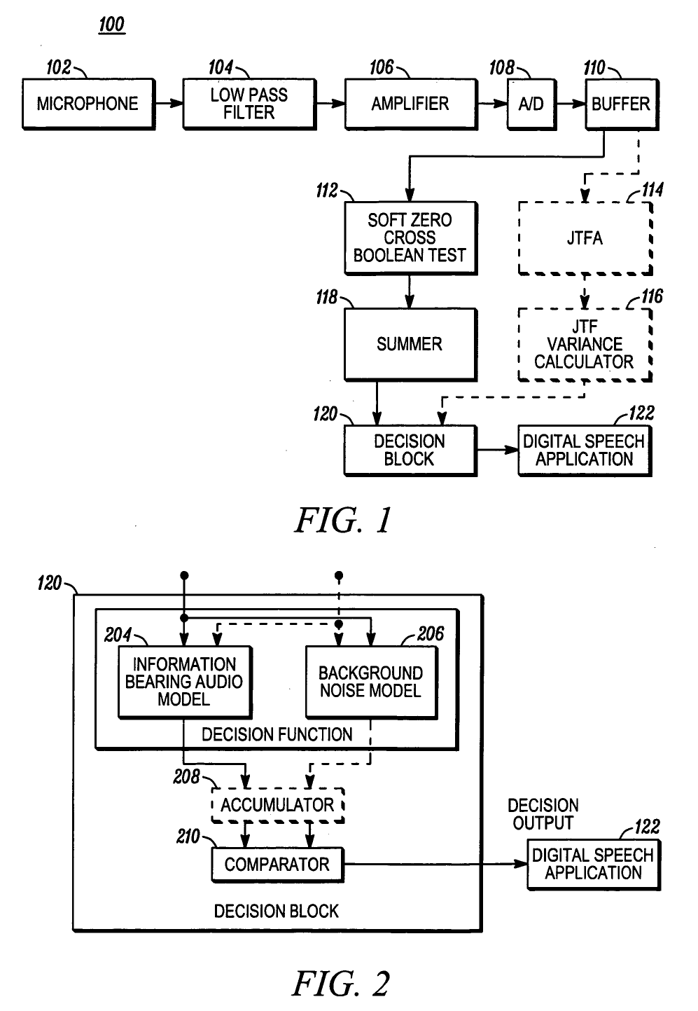

FIG. 1 is a functional block diagram of a system 100 for automatically distinguishing information bearing audio segments from background noise segments according to an embodiment. The system 100 comprises a microphone 102 coupled to a low pass filter 104, which is coupled to an amplifier 106, which is coupled to an Analog-to-Digital converter (A/D) 108, which is coupled to an audio sample buffer 110. The microphone 102 converts sound including speech and background noise to electrical signals. The electrical signals are filtered by the low-pass filter 104 to remove high frequency artifacts, which are excluded in accordance with the Nyquist frequency limit based on the sampling rate of the A/D 108. The amplifier 106 receives a relatively low amplitude signal from the low-pass filter 104 and outputs a relatively high amplitude equivalent signal. The A/D 108 digitizes the relatively high amplitude equivalent signal and outputs a series of digitized samples representing the relatively high amplitude equivalent signal. The series of digitized samples are fed into the audio sample buffer 110. The audio sample buffer 110 is typically a First-In-First-Out (FIFO) type.

The audio sample buffer 110 supplies the series of digitized samples to a Soft Zero Crossing (SZC) Boolean tester 112, and to a Joint Time-Frequency Analyzer (JTFA) 114. Both the SZC Boolean tester 112 and the JTFA 114 process many samples in order to produce one or a few output values. By way of illustration, the SZC Boolean tester 112 and the JTFA 114 can be designed to produce output values for each 200 sample frame taken at a sampling rate of 8000 samples per second, where the frames overlap by 120 samples. The SZC Boolean tester 112 and the JTFA may process different numbers of frames of speech samples in order to produce output. Overlapping frames are often used in digital audio processing systems, and if a digital audio processing system is designed to use overlapping frames, it may be convenient to use overlapping frames in the system 100 if the system 100 is incorporated into a larger digital audio processing system that uses overlapping frames. On the other hand, the system 100 does not need to use overlapping frames.

The JTFA 114 performs joint time-frequency analysis and outputs time-frequency component magnitudes to a joint time-frequency variance calculator 116. The time-frequency component magnitudes may be power or amplitude magnitudes. The JTFA 114 suitably supplies a magnitude for each of M frequencies and each of N time windows to the joint time-frequency variance calculator 11 where least one of M and N is greater than one. The joint time-frequency variance calculator 116 calculates the variance of the time-frequency component magnitudes. The variance of the time-frequency component magnitudes is a first discriminant that discriminates between audio including speech and audio that includes only background noise. (Note that as used in the present description the term background noise includes a cacophony of many speakers at relatively large distances from the microphone 102.) The use of the variance of the time-frequency component magnitudes is disclosed in co-pending patent application Ser. No. 10/060,511 filed Jan. 30, 2002, and entitled “Method and Apparatus for Speech Detection Using Time-Frequency Variance” which is assigned to the assignee of the present invention. The use of the JTFA 114 and the joint time-frequency variance calculator 116 is optional in the system 100.

The SZC Boolean tester 112 performs the following Boolean tests on successive samples:
((S_{K-1}>−h1 AND S_{K}<h2) OR (S_{K-1}<h3 AND S_{K}>−h4))

where, S_{K} is a k^{th} audio sample,
S_{K-1} is a (k−1)^{th} sample that precedes the k^{th} audio sample,
h1 is a first positive valued predetermined threshold,
h2 is a second positive valued predetermined threshold,
h3 is a third positive valued predetermined threshold, and
h4 is a fourth positive valued predetermined threshold.

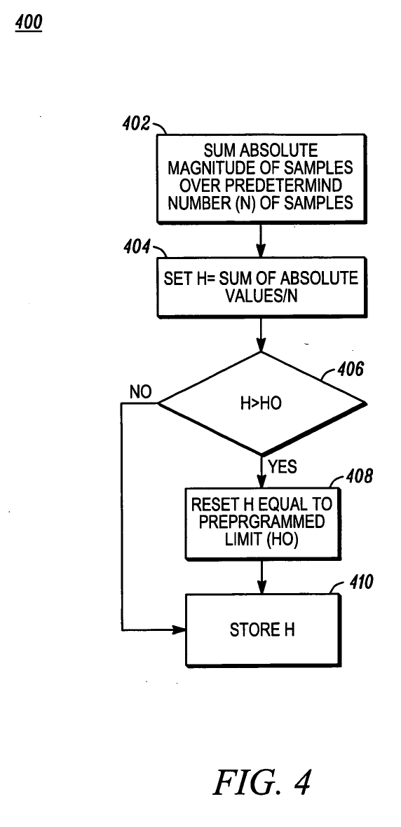

h1, h2, h3 and h4 are suitably set to a common threshold value h. Alternatively, h1, h2, h3 and h4 are set according to different values. The selection of a suitable value for h is described below with reference to FIG. 4. Each time the Boolean test is satisfied a summand is set to a finite value, e.g. one. When the Boolean test is not satisfied the summand is set to a different value, e.g., a lesser value, e.g., zero.

The summands produced by the Boolean test for successive samples are fed to a summer 118. The summer 118 suitably sums the summands produced by audio samples in a predetermined period of time. The period of time is suitably equal to or less than a period for which speech is considered stationary. By way of illustrative example, the summer 118 can sum summands generated by the Boolean test over a period of time of 25-30 milliseconds (200 to 240 samples at sampling frequency 8000 Hz). The sum of the summands produced by the Boolean test given above is a second discriminant between audio including speech and audio that includes only background noise. The discriminants that are output by the summer 118 and the joint time-frequency variance calculator 116 are supplied to a decision block 120.

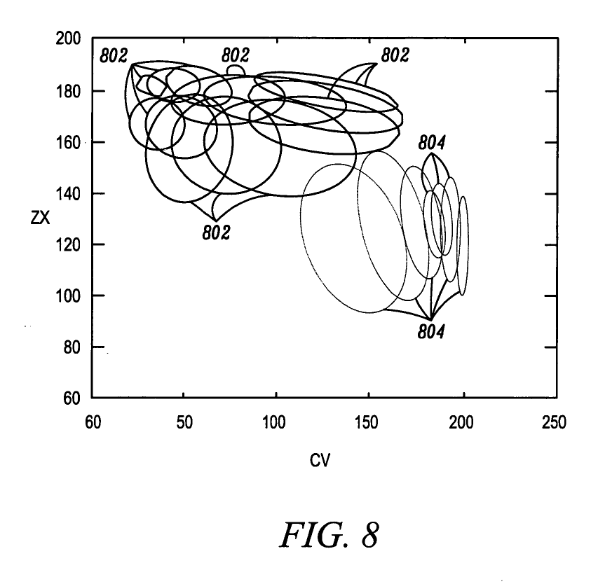

FIG. 2 is a more detailed block diagram of the decision block 120 in the system 100 shown in FIG. 1 according to the embodiment. As shown in FIG. 2, the decision block 120 includes a decision function 202 as its first stage. The decision function 202 includes an information (e.g., speech) bearing audio model 204 and a background noise model 206. Both models 204 206 receive the discriminant output by the summer 118 and the discriminant output by the JTF variance calculator 116. The information bearing audio model 204 processes the two discriminants and outputs a probability score that indicates the likelihood that an audio segment is information bearing audio. Similarly, the background noise model 206 processes the two discriminants and outputs a probability score that indicates the likelihood that each audio segment is purely background noise. As described further below, with reference to FIG. 8, the two models 204, 206 are suitably Gaussian mixture probability density functions.

As shown in FIG. 2 there is an optional accumulator 208 coupled to the decision function 202 for receiving the probability scores output by the two models 204, 206. The optional accumulator 208 serves to sum the probability scores over a predetermined number of periods, in order to filter out any spurious transients in the probability scores. (The probability scores for background noise and information bearing audio are summed separately.) Alternatively, rather than simply using the accumulator 208, time domain filtering such as FIR or IIR filtering is applied to the probability scores in order to filter spurious transients. Increasing the number of samples over which the summands generated by the Boolean test are summed by summer 118 and increasing the duration spanned by the time-frequency components processed by the JTF variance calculator 116 would also serve to suppress spurious transients, so that the accumulator 208 (or alternative time domain filter) would be redundant. Whether or not to include the accumulator 208 (or alternative time domain filter) is a matter of design choice. However, in as much as a frame size used in a larger system that incorporates the system 100 may be determined based on considerations beyond the scope of system 100, it may be desirable to use a shorter frame size, chosen in view of considerations external to the system 100, in block 116, 118, and then use to accumulator 208 to filter spurious transients.

A comparator 210 is coupled to the accumulator 208 for receiving the probability score sums calculated by the accumulator 208. The comparator 210 compares the sums of the probability scores and outputs an indication as to whether the probability score for information bearing audio or the probability score for background noise is higher. According to the embodiment shown in FIG. 2, the output of the comparator 210, is the output of the decision block 120. The output of the decision block 120 is received by a digital speech application 122. The digital speech application can, for example comprise a digital speech encoder or a speech recognition system.

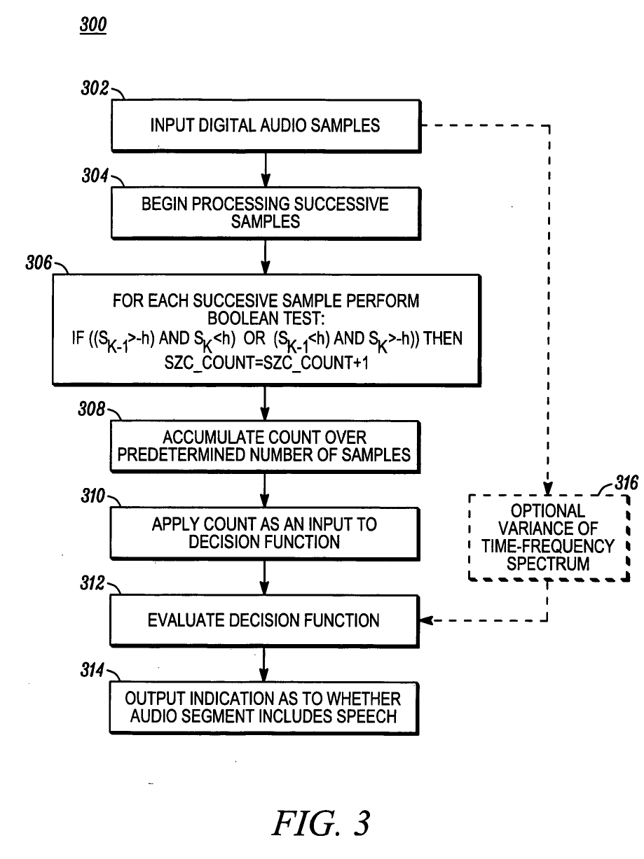

FIG. 3 is flowchart of a process 300 for automatically distinguishing information bearing audio segments from pure background noise segments according to the embodiment. The process 300 can be performed by application specific hardware by a programmed processor (e.g., programmable digital signal processor) or a combination of the two. In block 302 digital audio samples are input (e.g., from the A/D 108). Block 304 represents the commencement of processing of the audio samples. Block 306 represents application of the Boolean test given above and incrementing a ‘Soft Zero Crossing’ count (SZC_COUNT in FIG. 3) in the case that the Boolean test is met. Block 308 represents accumulating the count over a predetermined number of samples. Block 310 represents applying the count (accumulated over the predetermined number of samples) as an input to a decision function. Block 312 represents evaluating the decision function to which the count is applied as input. Block 314 represents outputting an indication as to whether the audio segment represented by the predetermined number of samples includes speech or merely contains background noise. Optional block 316 represents performing a joint time-frequency analysis on the digital audio samples input in block 302, and calculating the variance of the set of resulting time-frequency component magnitudes. If optional block 316 is used, the variance is also input into the decision function.

FIG. 4 is a flowchart of a process 400 of establishing the common threshold value h that is alternatively used by the system 100 shown in FIG. 1 and in the process shown in FIG. 3. The process 400 shown in FIG. 4 is preferably executed before the system 100 and the process 300 are used as described above. In block 402 absolute values of a predetermined number (N) of samples are summed. In block 404 the h, the common threshold that can be used in the Boolean test described above, is set to the average of the absolute values of the predetermined number (N) of samples. In the case that a user of the system 100 has not yet commenced speaking at the time that the samples used in blocks 402 and 404 are taken, blocks 402 and 404 will serve to set h to the average of the absolute magnitude of the background noise.

Block 406 is a decision block, the outcome of which depends on whether h, as set in block 404, exceeds a predetermined limit on h, denoted ho. If so, then in block 408 h is reset to the predetermined limit ho. If, on the other hand, it is determined in block 406 that h does not exceed ho, or after executing block 408, the process 400 proceeds to block 410 in which h is stored for use in the Boolean test. In the case that the user of the system 100 commences speaking while the predetermined number of samples are being taken, resulting in a large magnitude of the average absolute value being computed in block 404, block 406 in combination with block 408 will serve to limit the value of h. User's of the system 100 or other systems that implement the process 300 shown in FIG. 3 can be instructed (e.g., in instruction manuals) not to speak for a brief period (corresponding to the predetermined number (N) of samples) after the system 100 or other system implementing the process 300 is turned on. If the users abide such instructions, the process 400 shown in FIG. 4 will served to set h in accordance with existing ambient noise conditions. In effect the process 400 defines a piecewise function that gives h as a function of the average absolute magnitude of a predetermined number of samples.

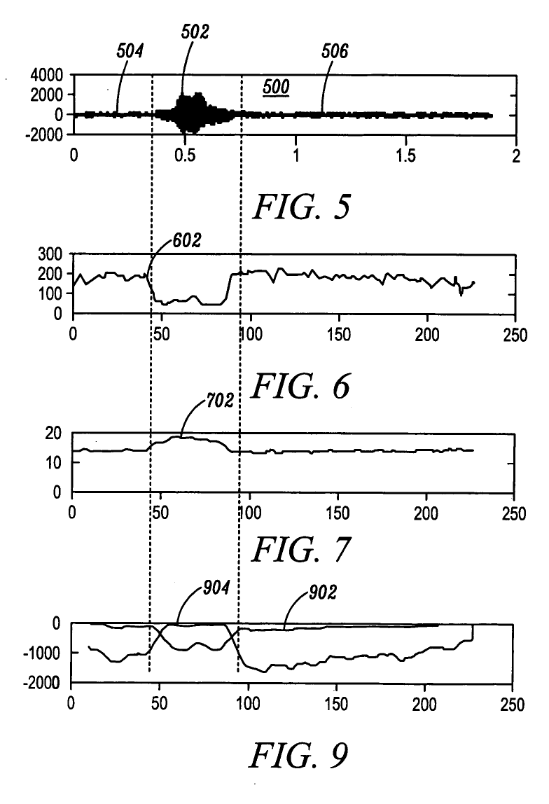

FIG. 5 is an audio waveform 500 including an information bearing segment (e.g. a word), 502 between a first background noise segment 504 and a second background noise segment 506. In FIG. 5 the abscissa indicates sample number and the ordinate is the waveform amplitude on linear scale. The audio waveform was sampled at a sampling rate of 8000 samples per second.

FIG. 6 is a graph including a time domain plot of the above described ‘Soft Zero Crossing’ based discriminant 602 between information bearing audio segments and pure background noise segments for the audio waveform shown in FIG. 5. Each point in the plot shown in FIG. 6 was based on summing the number of times for which the Boolean test was met (i.e., in block 118, 308) over one frame that included 200 samples taken a at sampling frequency of 8000 samples per second. The ordinate of the graph in FIG. 6 indicates the number of times that the Boolean test was satisfied within each one frame. As shown in FIG. 6 the value of the ‘Soft Zero Crossing’ based discriminant 602 dips down during the information bearing segment 502 of the audio waveform 500. An alternative simplified decision block would simply compare the value of the ‘Soft Zero Crossing’ based discriminant to a predetermined value in order to decide whether received audio includes speech (or other desired audio information) or merely contains background noise (e.g., a cacophony of sounds at a distance, automobile noise, etc.).

FIG. 7 is a graph including a time domain plot 702 of the joint time-frequency analysis based discriminant described above, for the audio waveform shown in FIG. 5. The plot shown in FIG. 7 was based on the variance of the magnitudes in a 3 by 3 set of time-frequency component magnitudes. (In other words, to calculate each point on the time domain plot 702, the magnitude in each of three frequency bands, in each of three time periods was determined giving a set of nine time-frequency component magnitudes and the variance of the nine magnitudes was calculated, yielding the value of the plot 702. The periods were 25 milliseconds and overlapped by 10 milliseconds. (The sampling rate was 8000 samples per second.) The first frequency band covered a frequency range of 100 to 1100 Hertz, the second frequency band covered a frequency range of 1100 to 2200 Hertz, and the third frequency band covered a range of 2200 to 3200 Hertz. (The preceding ranges are based on considering the frequency at which the frequency response reaches half the maximum value to be the bound of the pass band.) Although the second discriminant as shown in FIG. 7 was calculated using overlapping time periods, alternatively non-overlapping time periods are used. As shown in FIG. 7 the value of the first discriminant 702 rises during the information bearing segment 502.

Thus, as described above, and made clear in FIGS. 6-7 both the first discriminant and the second discriminant are able to discriminate information bearing audio (e.g., speech) from mere background noise. However, to obtain further improved discrimination, the first discriminant and the second discriminant are suitably combined.

According to certain embodiments of the invention, the first discriminant and the second discriminant are combined by making them the independent variables of two bivariate Probability Density Functions (PDF). A first of the two bivariate Probability Density Functions serves as the information (e.g., speech) bearing audio model 204 and a second of the two bivariate Probability Density Functions serves as the background noise model 206. The bivariate probability density functions are suitably Gaussian mixtures. A Gaussian mixture Probability Density Function, as used in the system 100, takes the form:

$$PDF ( X ) = {\sum }_{i = 1}^{L} {α}_{i} \frac{1}{{( 2 π )}^{1 / 2} {\vert \sum \vert}^{1 / 2}} exp ( - \frac{1}{2} {( X - {μ}_{i} )}^{T} {\sum }_{i}^{- 1} ( X - {μ}_{i} ) ) . \qquad Equ 1$$

where, X is an independent variable vector of length two that includes the first discriminant as one element and the second discriminant a second element (alternatively a different number of discriminants are used);
L is the number of mixture components in the Gaussian Mixture probability density function;
i is an index that refers to each mixture component;
αᵢ is a weight of an i^{th} Gaussian mixture component;
μᵢ is a vector mean of the i^{th} Gaussian mixture component;
Σᵢ is the covariance matrix of the i^{th} mixture component;

As noted above there will be a separate version of equation one for information (e.g., speech) bearing audio, and audio that merely contains background noise. Each will have its own mixture components each with its own weight, means variances, and covariance.

The weights, means, covariance matrices of each version of equation 1 (the version for information bearing audio and the version for mere background noise) are suitably determined by fitting equation 1 to training data (of corresponding type e.g. information bearing type or mere background noise type). A maximum likelihood method is suitably used to in fitting equation 1 to training data. A known maximum likelihood method for fitting equation 1 to training data is called the E-M algorithm. The E-M algorithm is described in D. M. Titterington, A. F. M. Smith, and U. E. Makov, Statistical Analysis Of Finite Mixture Distributions. John Wiley & Sons, 1985.

FIG. 8 is a graph including level plots for Gaussian mixture components of a model for background noise 802 (based on equation 1) and a model for audio segments with speech 804 (based on equation 1). In FIG. 8 the horizontal axis gives the value of the joint time-frequency analysis based discriminant and the vertical axis gives the value of the soft zero crossing based discriminant. Note that the values on the horizontal axis of FIG. 8 are scaled to give a maximum value of 256. In general, the level plots are elliptical, though if the variances for the first and second discriminant, for a particular mixture component happened to be equal, the level plot for that particular mixture component would be a circle. The level plots are at the one-sigma level. Table I below gives the values of the parameters of the information bearing audio model 204 and the background noise model 206 for a prototype system. The natural log of the weights αᵢ are given in the table in lieu of the weights. In order to reduce computational cost the natural log of the models 204, 206 are sometimes used.

TABLE I

| | | | | | | |
|---|---|---|---|---|---|---|
| i | Ln(αᵢ) | μ₁ⁱ | μ₂ⁱ | c₁₁ⁱ | c₁₂ⁱ | c₂₂ⁱ |

INFORMATION BEARING AUDIO MODEL

| | | | | | | |
|---|---|---|---|---|---|---|
| 1 | −7.806 | 142.583 | 122.758 | 414.453 | −132.309 | 410.866 |
| 2 | 6.685 | 179.067 | 128.522 | 67.925 | −31.502 | 253.616 |
| 3 | −7.394 | 163.111 | 127.042 | 185.435 | −110.390 | 426.954 |
| 4 | −4.839 | 197.802 | 122.386 | 1.991 | −4.627 | 213.936 |
| 5 | −8.115 | 98.795 | 134.644 | 1025.728 | −100.349 | 285.771 |
| 6 | −5.511 | 190.069 | 129.281 | 17.251 | −14.992 | 102.852 |
| 7 | −5.713 | 193.222 | 126.846 | 9.862 | −21.170 | 280.751 |
| 8 | −5.589 | 186.383 | 127.663 | 23.501 | −12.288 | 83.504 |

BACKGROUND NOISE AUDIO MODEL

| | | | | | | |
|---|---|---|---|---|---|---|
| 1 | −6.549 | 126.047 | 179.092 | 792.472 | −89.852 | 25.791 |
| 2 | −7.761 | 102.119 | 157.326 | 837.330 | −58.267 | 170.725 |
| 3 | −7.006 | 98.730 | 175.613 | 732.256 | −29.859 | 43.350 |
| 4 | −6.608 | 48.329 | 165.535 | 185.520 | −8.739 | 75.440 |
| 5 | −6.063 | 57.933 | 181.187 | 164.768 | −17.282 | 30.209 |
| 6 | −7.470 | 73.331 | 157.998 | 444.911 | −3.783 | 175.377 |
| 7 | −5.692 | 44.339 | 181.478 | 102.090 | 0.213 | 21.833 |
| 8 | −4.530 | 32.315 | 181.518 | 41.737 | −9.863 | 7.552 |
| 9 | −6.106 | 35.338 | 166.544 | 100.066 | −4.498 | 51.152 |
| 10 | −7.312 | 53.207 | 157.554 | 273.037 | 39.846 | 214.229 |
| 11 | −7.216 | 125.132 | 166.298 | 840.006 | −51.304 | 58.939 |
| 12 | −7.059 | 126.461 | 173.331 | 913.659 | −109.429 | 50.626 |
| 13 | −6.773 | 73.989 | 175.830 | 460.442 | 16.757 | 42.607 |

In table I, the first column identifies mixture components by index I, the second column gives the natural log of the mixture component weight, the third column gives the mean of the first, joint time-frequency based, discriminant, and the fourth column gives the mean of the second, soft zero crossing based, discriminant, the fifth column gives the variance of the first discriminant, the sixth column gives the covariance of the two discriminants and the seventh column gives the variance of the second discriminant. Each row gives information for one mixture component. As indicated in the table, a first set of rows describes an example of a model for information bearing (e.g., speech) audio and a second set of rows describes an example of a model for background noise audio. The model for background noise audio can be specialized for different types of background noise depending on the environment(s) in which the system 100 is expected to be used, and the model for information bearing audio (e.g., speech) can be specialized for different types of information bearing audio (e.g., speech in different languages).

The decision function 202 suitably includes both bivariate probability density functions (e.g., in the form of programming instructions). In order to make a determination as to whether a particular segment of audio is likely to include speech, the decision function suitably evaluates both bivariate probability density functions with values of the first and second discriminant extracted from a particular segment of audio. The values of the two bivariate probability density functions are then output to the accumulator 208 (or if the accumulator 208 is not used, directly to the comparator 210).

The first discriminant and the second discriminant have a relatively low correlation. According to alternative embodiments multivariate models that are functions of more than two discriminants are used in the decision function 204.

FIG. 9 is graph including a first time domain plot 902 of the probability score yielded by the model for background noise shown in FIG. 8 and a second time domain plot 904 of the probability score yield by the model for speech shown in FIG. 8 when evaluated with the audio waveform shown in FIG. 5. As shown in FIG. 9 the probability score for speech exceeds the probability score for background noise during most of the information bearing segments shown in FIG. 5.

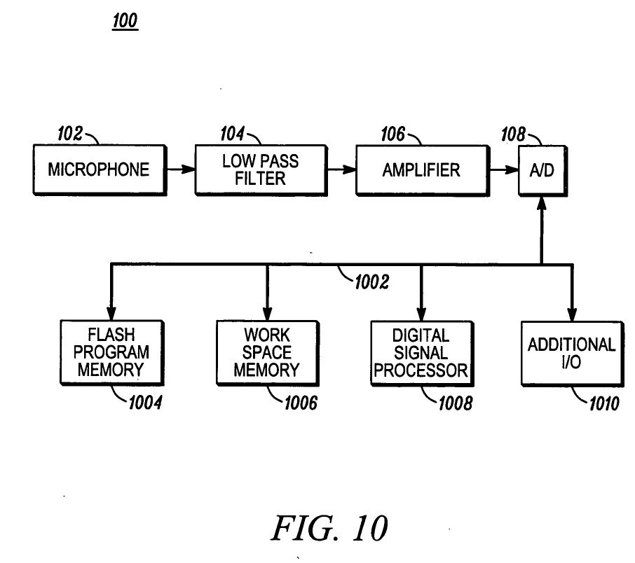

FIG. 10 is a hardware block diagram of the system 100 shown in FIG. 1 according to an embodiment of the invention. As shown in FIG. 10, the AID 108 is coupled to a digital signal bus 1002. A flash program memory 1004, a work space memory 1006, a digital signal processor (DSP) 1008 and an additional Input/Output interface (I/O) 1010 are coupled to the digital signal bus 1002. The flash program memory 1004 is used to store one or more programs that embody the system 100 as shown in FIGS. 1-2 and the flowcharts 300, 400 shown in FIGS. 3-4. The one or more programs are executed by the DSP 1008. Alternatively, another type of memory is used in lieu of the flash program memory 1004. The work space memory 1006 can be used as the audio sample 110 or a separate buffer (not shown) can be provided. The additional I/O 1010 is suitably used to interface to other user interface components such as, for example, a display screen, a touch screen, a loudspeaker (e.g., for synthesized voice output) and/or a keypad. The additional I/O can also be used to connect to a communication system, such as, for example, a voice and/or data network.

Although FIG. 10 shows a programmable DSP hardware, alternatively the system 100 is implemented in an Application Specific Integrated Circuit (ASIC).

Although, reference has been made above discriminating between audio including speech and audio containing only background noise, alternatively, in lieu or in addition to speech the system 100 and the process 300 can be used to discriminate between other information bearing audio and audio that includes only background noise. Examples of other information bearing audio include, by way of nonlimiting example, music, acoustic modem signals (such as used for underwater communication), sounds made by animals (e.g., whale song, infrasonic elephant sounds). In any case, if one such sound, that is intended to be recognized is present along with a lower amplitude cacophony of other such sounds, the lower amplitude cacophony is considered background noise for our purposes. The information bearing segments may also include background noise, but unlike the background noise segments they also include audio information that is intended to be recognized.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

What is claimed is:

1. A method of discriminating information bearing audio segments and background noise audio segments comprising:
for each k^{th} sample in a series of samples, testing if a Boolean test:
((S_{K-1}>−h1 AND S_{K}<h2) OR (S_{K-1}<h3 AND S_{K}>−h4))
where, S_{K} is a k^{th} audio sample,
S_{K-1} is a (k−1)^{th} sample that precedes the k^{th} audio sample,
h1 is a first, positive valued predetermined threshold,
h2 is a second positive valued predetermined threshold,
h3 is a third positive valued predetermined threshold, and
h4 is a fourth positive valued predetermined threshold,
is met, and if so, incrementing a count;
after a predetermined number of samples, inputting the count into a decision function; and
evaluating the decision function to determine if the audio segment is more likely to be background noise or information bearing audio.

2. The method according to claim 1 wherein: h1, h2, h3, h4 are equal to a common value h.

3. The method according to claim 2 where h is established by determining an average absolute magnitude audio sample level and evaluating a piecewise defined function that is equal to the average absolute magnitude audio sample level up to a predetermined limit HO, and beyond HO is equal to HO.

4. The method according to claim 1 further comprising:
processing the audio segment to compute, in addition to the count, at least one other discriminant between information bearing audio and background noise; and
inputting the at least one other discriminant into the decision function

5. The method according to claim 1 further comprising:
processing the series of samples to obtain a plurality of measurements of the magnitude corresponding to a plurality of frequency bands;
computing a variance of the plurality of measurements of magnitude; and
inputting the variance of the plurality of measurements of magnitude to the decision function.

6. The method according to claim 1 further comprising:
processing the series of samples to obtain a plurality of measurements of magnitude for a plurality of time intervals;
computing a variance of the measurements of magnitude; and
inputting the variance of the measurements of magnitude to the decision function.

7. The method according to claim 1 further comprising:
performing joint time frequency analysis on the series of samples to compute a plurality of time-frequency magnitudes that includes magnitudes corresponding to different times and magnitudes corresponding to different frequencies;
computing a variance of the time-frequency magnitudes; and
inputting the variance of the time-frequency magnitudes to the decision function.

8. An apparatus for discriminating information bearing audio segments and background noise audio segments, the apparatus comprising:
a Boolean tester for applying a Boolean test:
((S_{K-1}>−h1 AND S_{K}<h2) OR (S_{K-1}<h3 AND S_{K}>−h4))
where, S_{K} is a k^{th} audio sample,
S_{K-1} is a (k−1)^{th} sample that precedes the k^{th} sample, and
h1 is a first positive valued predetermined threshold,
h2 is a second positive valued predetermined threshold,
h3 is a third positive valued predetermined threshold,
h4 is a fourth positive valued predetermined threshold, to each k^{th} sample in a series of samples; and
a summer for summing, over a predetermined number of samples, a number of times that the Boolean tester produces a positive result and outputting a sum;
a decision function evaluator for receiving the sum as input and evaluating a decision function.

9. The apparatus according to claim 8 wherein h1, h2, h3, h4 are equal to a common value h.

10. The apparatus according to claim 8 further comprising:
a joint time frequency analyzer for evaluating a plurality of time-frequency magnitudes; and
a joint time frequency variance calculator for receiving a plurality of time-frequency magnitudes and outputting a variance of the plurality of time-frequency magnitudes; and
wherein, the decision function evaluator is adapted to received the variance of the plurality of time-frequency magnitudes as input and evaluate the decision function based, in part, on the variance.

11. An apparatus for discriminating information bearing audio segments and background noise audio segments, the apparatus comprising:
a processor;
a memory for storing programming instructions, said memory coupled to said processor, wherein said processor is programmed by said programming instructions to:
test whether a Boolean test:
((S_{K-1}>−h1 AND S_{K}<h2) OR (S_{K-1}<h3 AND S_{K}>−h4))
where, S_{K} is a k^{th} audio sample,
S_{K-1} is a (k−1)^{th} sample that precedes the k^{th} sample, and
h1 is a first positive valued predetermined threshold,
h2 is a second positive valued predetermined threshold,
h3 is a third positive valued predetermined threshold,
h4 is a fourth positive valued predetermined threshold,
is met for each k^{th} sample in a series of samples, and if so, increment a count;
after a predetermined number of samples, input the count into a decision function; and
evaluate the decision function to determine if the audio segment is more likely to be background noise or information bearing audio.

12. The apparatus according to claim 11 wherein h1 h1, h2, h3, h4 are equal to a common value h.

13. The apparatus according to claim 11 wherein the processor is also programmed to:
establish h by:
determining an average absolute magnitude audio sample level; and
evaluate a piecewise defined function that is equal to the average absolute magnitude audio sample level up to a predetermined limit HO, and beyond HO is equal to HO.

14. The apparatus according to claim 11 wherein the processor is also programmed to:
process the audio segment to compute, in addition to the count, at least one other discriminant between information bearing audio and background noise; and
input the at least one other discriminant into the decision function.

15. The apparatus according to claim 11 further wherein the processor is further programmed to:
process the series of samples to obtain a plurality of measurements of the magnitude corresponding to a plurality of frequency bands;
compute a variance of the plurality of measurements of magnitude; and
input the variance of the plurality of measurements of magnitude to the decision function.

16. The apparatus according to claim 11 wherein the processor is also programmed by said programming instructions to:
process the series of samples to obtain a plurality of measurements of magnitude for a plurality of time intervals;
compute a variance of the plurality of measurements of magnitude; and
input the variance of the measurements of magnitude to the decision function.

17. The apparatus according to claim 11 wherein the processor is also programmed by said programming instructions to:
perform joint time frequency analysis on the series of samples to compute a plurality of time-frequency magnitudes that includes magnitudes corresponding to different times and magnitudes corresponding to different frequencies;
compute a variance of the time-frequency magnitudes; and
input the variance of the time-frequency magnitudes to the decision function.

18. A computer readable medium storing programming instructions for discriminating information bearing audio segments and background noise audio segments, including programming instructions for:
for each k^{th} sample in a series of samples, testing if a Boolean test:
((S_{K-1}>−h1 AND S_{K}<h2) OR (S_{K-1}<h3 AND S_{K}>−h4))
where, S_{K} is a k^{th} audio sample,
S_{K-1} is a (k−1)^{th} sample that precedes the k^{th} audio sample,
h1 is a first positive valued predetermined threshold,
h2 is a second positive valued predetermined threshold,
h3 is a third positive valued predetermined threshold, and
h4 is a fourth positive valued predetermined threshold,
is met, and if so, incrementing a count;
after a predetermined number of samples, inputting the count into a decision function; and
evaluating the decision function to determine if the audio segment is more likely to be background noise or information bearing audio.

19. The computer readable medium according to claim 18 wherein: h1,h2,h3, h4 are equal to a common value h.

20. The computer readable medium according to claim 19 where h is established by determining an average absolute magnitude audio sample level and evaluating a piecewise defined function that is equal to the average absolute magnitude audio sample level up to a predetermined limit HO, and beyond HO is equal to HO

21. The computer readable medium according to claim 18 further comprising programming instructions for:
processing the audio segment to compute, in addition to the count, at least one other discriminant between information bearing audio and background noise; and
inputting the at least one other discriminant into the decision function

22. The computer readable medium according to claim 18 further comprising programming instructions for:
processing the series of samples to obtain a plurality of measurements of the magnitude corresponding to a plurality of frequency bands;
computing a variance of the plurality of measurements of magnitude; and
inputting the variance of the plurality of measurements of magnitude to the decision function.

23. The computer readably medium according to claim 18 further comprising programming instructions for:
processing the series of samples to obtain a plurality of measurements of magnitude for a plurality of time intervals;
computing a variance of the measurements of magnitude; and
inputting the variance of the measurements of magnitude to the decision function.

24. The computer readable medium according to claim 18 further comprising programming instructions for:
performing joint time frequency analysis on the series of samples to compute a plurality of time-frequency magnitudes that includes magnitudes corresponding to different times and magnitudes corresponding to different frequencies;
computing a variance of the time-frequency magnitudes; and
inputting the variance of the time-frequency magnitudes to the decision function.
